(19) United States
(12) Patent Application Publication
(10) Pub. No.: US 2026/0234370 A1
(43) Pub. Date: Aug. 13, 2026

(54) RUBBER COMPOSITION AND WEATHER STRIP

(71) Applicant: NISHIKAWA RUBBER CO., LTD., Hiroshima (JP)

(72) Inventor: Nobuyuki SAKUDA, Hiroshima (JP)

(21) Appl. No.: 19/533,736

(22) Filed: Feb. 9, 2026

(30) Foreign Application Priority Data
Feb. 13, 2025 (JP) 2025-021742

(51) Int. Cl. C08K 5/55; B60J 10/15; B60J 10/86

(52) U.S. Cl. CPC C08K 5/55; B60J 10/15; B60J 10/86

(57) ABSTRACT

Provided is a rubber composition that achieves favorable vulcanization efficiency. The rubber composition contains a non-diene-based rubber and a boron-based surfactant, in which a contained amount of the boron-based surfactant is more than 0.2 parts by weight and not more than 1.5 parts by weight, relative to 100 parts by weight of the non-diene-based rubber.

This Nonprovisional application claims priority under 35 U.S.C. § 119 on Patent Application No. 2025-021742 filed in Japan on Feb. 13, 2025, the entire contents of which are hereby incorporated by reference.

### TECHNICAL FIELD

The present invention relates to a rubber composition and a weather strip.

### BACKGROUND ART

Vulcanization of a rubber composition provides elasticity and enables molding of a variety of rubber products. Since vulcanization of a rubber involves heating, a method to improve efficiency of a vulcanization process and to save energy necessary for heating is desired.

For example, Patent Literature 1 indicates that ultra high frequency (UHF) heat generation efficiency is improved by inclusion of polyethylene glycol, which has a high dielectric constant.

### CITATION LIST

### Patent Literature

[Patent Literature 1]
Japanese Patent Application Publication Tokukaihei No. 6-306222

### SUMMARY OF INVENTION

### Technical Problem

However, the inventors of the present invention have found that polyethylene glycol has a limited effect on improvement of UHF heat generation efficiency.

An object of an aspect of the present invention is to realize a rubber composition and the like that enable a vulcanization process to be carried out more efficiently than conventional techniques.

### Solution to Problem

In order to attain the object, a rubber composition in accordance with an aspect of the present invention contains a non-diene-based rubber and a boron-based surfactant, a contained amount of the boron-based surfactant being more than 0.2 parts by weight and not more than 1.5 parts by weight, relative to 100 parts by weight of the non-diene-based rubber.

### Advantageous Effects of Invention

According to an aspect of the present invention, it is possible to realize a rubber composition and the like that enable a vulcanization process to be carried out more efficiently than conventional techniques.

### BRIEF DESCRIPTION OF DRAWINGS

FIG. 1 is a schematic diagram illustrating an automobile to which a weather strip in accordance with an embodiment is attached.

FIG. 2 is a schematic diagram illustrating a heating location in evaluation of UHF heat generation amount in Examples.

FIG. 3 is a diagram illustrating results of evaluating UHF heat generation amount under heating at 1 kW and at a setting temperature of 30° C. in Examples.

FIG. 4 is a diagram illustrating results of evaluating UHF heat generation amount under heating at 2 kW and at a setting temperature of 30° C. in Examples.

FIG. 5 is a diagram illustrating results of evaluating UHF heat generation amount under heating at 2 kW and at a setting temperature of 100° C. in Examples.

FIG. 6 is a diagram illustrating results of evaluating UHF heat generation amount under heating at 3 kW and at a setting temperature of 100° C. in Examples.

FIG. 7 is a diagram illustrating results of evaluating UHF heat generation amount under heating at 4 kW and at a setting temperature of 100° C. in Examples.

FIG. 8 is a diagram illustrating results of evaluating volume resistance in Examples.

### DESCRIPTION OF EMBODIMENTS

### [Rubber Composition]

A rubber composition in accordance with an embodiment of the present invention contains a non-diene-based rubber and a boron-based surfactant, a contained amount of the boron-based surfactant being more than 0.2 parts by weight and not more than 1.5 parts by weight, relative to 100 parts by weight of the non-diene-based rubber. Note that the rubber composition in accordance with an embodiment of the present invention may be hereinafter referred to as a “present rubber composition”.

### (Non-Diene-Based Rubber)

The non-diene-based rubber is a synthetic rubber having a polymer structure, in which a main chain of the polymer has no double bond or the number of double bonds contained in the main chain is small. Examples of the case where “the number of contained double bonds is small” include a case where some of monomers constituting the polymer include monomers that each introduce a diene structure to the main chain, and a proportion of the monomers that each introduce a diene structure to the main chain is smaller than a predetermined proportion. The “predetermined proportion” of the monomers that each introduce a diene structure to the main chain in this case may be, for example, 5 mol % or less, 3 mol % or less, 2 mol % or less, or 1 mol % or less, relative to the entire polymer.

Examples of such a non-diene-based rubber include a butyl rubber. The butyl rubber is obtained by copolymerizing isobutylene with isoprene typically in an amount of 0.6 mol % or more and 3 mol % or less. The butyl rubber contains double bonds in the main chain. However, the number of the double bonds is small and therefore the butyl rubber has properties as a non-diene-based rubber.

Examples of the case where “the number of contained double bonds is small” include a case where, in principle, the main chain has no double bond but a double bond is contained in the main chain due to an unintended chemical reaction such as a polymerization reaction or a change with time.

Examples of the non-diene-based rubber include an ethylene-α-olefin-non-conjugated diene rubber (EPDM), a butyl rubber, a urethane rubber, a silicone rubber, an acrylic rubber, and a fluorocarbon rubber. Among those, in a case where the present rubber composition is used in an automotive component such as a weather strip, the EPDM is preferable as the non-diene-based rubber because favorable physical properties can be easily obtained.

Examples of α-olefin in the EPDM include propylene, 1-butene, 1-pentene, 1-hexene, 4-methyl-1-pentene, 1-octene, 1-decene, and the like. Examples of the non-conjugated diene include 1,4-hexadiene, dicyclopentadiene, 5-ethylidene-2-norbornene, 5-vinyl-2-norbornene, and the like.

A contained amount of the non-diene-based rubber may be not less than 30 parts by weight, not less than 40 parts by weight, not less than 50 parts by weight, not less than 60 parts by weight, or not less than 70 parts by weight, relative to a total of 100 parts by weight of the present rubber composition.

The non-diene-based rubber is superior to a diene-based rubber in weatherability because the non-diene-based rubber has no double bond in the main chain. In a case where the non-diene-based rubber is a rubber such as EPDM that has a double bond in the side chain, a vulcanization reaction can be carried out by sulfur. However, a vulcanization reaction rate by sulfur tends to be longer than that of a diene-based rubber. The present rubber composition contains a boron-based surfactant, and it is thus possible to improve the vulcanization reaction rate of the non-diene-based rubber.

The term “vulcanization” as used herein is intended for general cross-linking of a non-diene-based rubber, and is not limited to a reaction using sulfur. Cross-linking of a non-diene-based rubber using a cross-linking agent (vulcanization agent) other than sulfur is also included in an aspect of vulcanization.

### (Boron-Based Surfactant)

The boron-based surfactant is a surfactant that contains boron. Examples of the boron-based surfactant include a glycerol borate fatty acid ester. The glycerol borate may be in a form where two glycerols or fatty acid esters thereof are bound to boron. The glycerol borate only needs to be configured such that at least one glycerol has a structure of a fatty acid ester, that is, two glycerols may each have a structure of a fatty acid ester.

The fatty acid may be a saturated fatty acid or an unsaturated fatty acid. The carbon number of the fatty acid is not particularly limited, and may be, for example, 4 or more, 5 or more, 6 or more, 7 or more, 8 or more, or 9 or more. In a case where the fatty acid is an unsaturated fatty acid, the unsaturated fatty acid may be a monounsaturated fatty acid or a polyunsaturated fatty acid.

Examples of the boron-based surfactant include glycerol borate-oleate, glycerol borate-laurate, glycerol borate-palmitate, glycerol borate-stearate, glycerol borate-isostearate, and glycerol borate-hydroxystearate. Among those, the glycerol borate-oleate is preferable from the viewpoint of availability. Examples of commercially available glycerol borate-oleate include EMULBON S-80 and EMULBON T-80 manufactured by Toho Chemical Industry Co., Ltd.

Examples of the boron-based surfactant also include various glycerol borate fatty acid esters which are disclosed as organoboron compounds in Japanese Patent Publication, Tokukousho, No. 49-011311.

The boron-based surfactant may be glycerol borate-polyoxyethylene ether or glycerol borate polyoxyethylene ether fatty acid ester. The glycerol borate polyoxyethylene ether fatty acid ester is an example of the glycerol borate fatty acid ester. In a case where the boron-based surfactant is such a polymer compound, a molecular weight of the boron-based surfactant may be 500 or more and 10,000 or less.

In the present rubber composition, the contained amount of the boron-based surfactant may be more than 0.2 parts by weight and not more than 1.5 parts by weight, relative to 100 parts by weight of the non-diene-based rubber. A lower limit of the contained amount of the boron-based surfactant may be not less than 0.3 parts by weight, not less than 0.4 parts by weight, or not less than 0.5 parts by weight. In a case where the contained amount of the boron-based surfactant relative to the non-diene-based rubber is more than 0.2 parts by weight, it is possible to sufficiently achieve an enhancing effect on the vulcanization rate of the rubber composition. In a case where the contained amount of the boron-based surfactant relative to the non-diene-based rubber is not more than 1.5 parts by weight, an advantageous effect exerted by the boron-based surfactant can be obtained in a range in which a raw material cost of the boron-based surfactant is not excessive.

The inventors of the present invention have found that, by inclusion of a boron-based surfactant in the present rubber composition, it is possible to shorten the vulcanization rate and to achieve an enhancing effect on heating efficiency in vulcanization. Specifically, the boron-based surfactant makes it possible to shorten T90, which indicates a time necessary for vulcanization of a rubber composition and is measured with CURELASTOMETER by a method in conformity to JIS K6300-2:2001. In addition, the boron-based surfactant improves UHF heat generation property of the rubber composition, and it is thus possible to shorten a time taken to raise a temperature of the rubber composition.

The inclusion of the boron-based surfactant does not reduce a scorch time (t5) in evaluation of Mooney viscosity, which is measured by a method in conformity to JIS K6300-1:2013. The scorch time is an indicator of a time period until a rubber scorch occurs, and the scorch time is preferably long. The boron-based surfactant is capable of enhancing the vulcanization rate indicated by T90, while having no adverse effect on the scorch time.

The inventors of the present invention have also found that, in a case where the present rubber composition contains a boron-based surfactant, it is possible to improve mechanical physical properties of a molded body after vulcanization. Specifically, the boron-based surfactant can improve Tb (tensile strength at break) and Eb (elongation at break) measured by methods in conformity to JIS K6251: 2017. Moreover, it is possible to reduce a value of compressive permanent set measured by a method in conformity to JIS K6262: 2013. Therefore, resilience (elasticity) as a rubber can be improved.

Thus, it is a novel finding by the inventors of the present invention that the boron-based surfactant is capable of achieving both improvement of vulcanization characteristics of a rubber composition and improvement of mechanical physical properties of a molded body. Specifically, by the boron-based surfactant, a heating time in vulcanization of the rubber composition can be shortened. The shortening of the heating time leads to a shorter production time for the rubber composition and thus production efficiency is improved. Furthermore, energy that is necessary for heating can be saved, and a production cost can be reduced. A molded body of the rubber composition produced in this manner has excellent mechanical physical properties, and can thus be expected to have a longer lifetime than a conventional one.

Such effects will also contribute to achieving, for example, the sustainable development goals (SDGs) advocated by the United Nations, specifically, Goal 7, “Improve energy efficiency” and Goal 12, “Ensure sustainable consumption and production patterns”, and the like.

### (Other Components)

The present rubber composition may further contain other components in addition to the non-diene-based rubber and the boron-based surfactant. Examples of such other components include, but not particularly limited to, a surfactant other than the boron-based surfactant, a vulcanization agent, a vulcanization accelerating agent, a processing aid, a process oil, a filler, a colorant, and a dehydration agent.

Examples of the vulcanization agent include sulfur, peroxide, resin, amine, and polyol. Among those, in a case where a non-diene-based rubber having a double bond in the side chain or the like is used, the cross-linking agent is preferably sulfur.

The vulcanization accelerating agent can be selected, as appropriate, according to a type of the vulcanization agent. In a case where the vulcanization agent is sulfur, examples of the vulcanization accelerating agent include a thiuram-based vulcanization accelerating agent, a thiazole-based vulcanization accelerating agent, a sulfenamide-based vulcanization accelerating agent, a dithiocarbamate-based vulcanization accelerating agent, a guanidine-based vulcanization accelerating agent, and the like. The present rubber composition may contain only one type of the vulcanization accelerating agents or may contain two or more types of the vulcanization accelerating agents.

### (Method for Producing Present Rubber Composition)

A method for producing the present rubber composition is not particularly limited, and may include, for example, a process of mixing a non-diene-based rubber with a boron-based surfactant and optionally with other components. The mixing may be carried out, for example, using a kneading machine such as a Banbury mixer, an internal mixer, a kneader, or an open roll.

### (Application of Present Rubber Composition)

According to the present rubber composition, by carrying out vulcanization and molding, it is possible to obtain a molded body of the present rubber composition. In other words, a molded body in accordance with an embodiment of the present invention is obtained by carrying out a process of vulcanizing and molding the present rubber composition. Hereinafter, the molded body in accordance with an embodiment of the present invention may be referred to as a “present molded body”.

A vulcanization reaction of the present rubber composition can proceed by adding a vulcanization agent and optionally an additive such as a vulcanization accelerating agent, and then heating a resultant mixture. Heating for vulcanization and molding are preferably carried out in parallel.

A molding method of the present molded body is not particularly limited, and may be, for example, an extrusion molding or die molding. Since the UHF heat generation property of the rubber composition is improved, the present rubber composition can be suitably used for vulcanization molding using a vulcanization device which is provided with a UHF oscillator. For example, the present rubber composition is suitable for extrusion molding using a vulcanization oven.

Examples of the present molded body include, but not particularly limited to, a rubber component for an automobile. Suitable examples of the rubber component for an automobile include a weather strip. The present molded body is also applicable to a gasket for residential use.

### (Weather Strip)

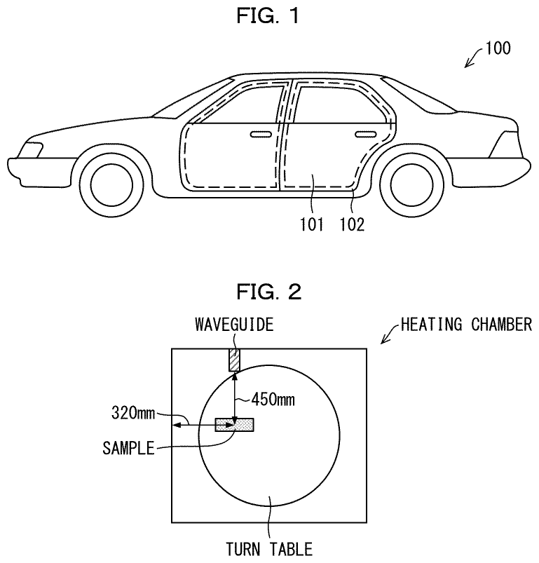

FIG. 1 is a side view schematically illustrating an automobile 100 to which a weather strip 102, which is the present molded body, is attached. As illustrated in FIG. 1, the present molded body may be a weather strip 102 to be attached to a door 101 of an automobile 100. That is, the present rubber composition can be suitably used for the weather strip 102 to be attached to the door 101 of the automobile 100.

The weather strip 102 is a member that is attached to a peripheral edge of the door 101 and seals a gap between the door 101 and an opening of the automobile 100. The door 101 is, but not limited to, a cabin door of the automobile 100. A door of the automobile 100 to which the weather strip 102 is attached may be, for example, a luggage compartment door, an engine compartment door (also called an engine hood or a bonnet), or another door.

The weather strip 102 may be obtained by extrusion-molding the present rubber composition. The weather strip 102 may include an extrusion-molded portion and a die-molded portion. In this case, the present rubber composition only needs to be used in at least a part of the extrusion-molded portion and the die-molded portion, and may be used for both the extrusion-molded portion and the die-molded portion. In other words, the weather strip 102 in accordance with an embodiment of the present invention only needs to have a portion constituted by the present rubber composition.

Aspects of the present invention can also be expressed as follows:

A rubber composition in accordance with an aspect 1 of the present invention contains a non-diene-based rubber and a boron-based surfactant, a contained amount of the boron-based surfactant being more than 0.2 parts by weight and not more than 1.5 parts by weight, relative to 100 parts by weight of the non-diene-based rubber.

The rubber composition in accordance with an aspect 2 of the present invention may be configured, in the aspect 1, such that the non-diene-based rubber is an ethylene-α-olefin-non-conjugated diene rubber.

The rubber composition in accordance with an aspect 3 of the present invention may be configured, in the aspect 1 or 2, such that the boron-based surfactant is a glycerol borate fatty acid ester.

The rubber composition in accordance with an aspect 4 of the present invention may be configured, in any of the aspects 1 through 3, such that the rubber composition is used for vulcanization molding using a vulcanization device which is provided with a UHF oscillator.

The rubber composition in accordance with an aspect 5 of the present invention may be configured, in any of the aspects 1 through 4, such that the rubber composition is for a weather strip to be attached to a door of an automobile.

A weather strip in accordance with an aspect 6 of the present invention is a weather strip to be attached to a door of an automobile, the weather strip having a portion constituted by the rubber composition described in the aspect 5.

### [Additional Remarks]

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

The following description will discuss Examples of the present invention.

### [Composition]

Rubber compositions in accordance with Examples and Comparative Examples were experimentally prepared. Each of the rubber compositions was obtained by mixing components indicated in Tables 1 and 2 below using a Banbury mixer. Contained amounts of the components were described in terms of parts by weight seen when a contained amount of an EPDM polymer, which is the non-diene-based rubber, was set to 100 parts by weight. PEG4000 is polyethylene glycol manufactured by NOF CORPORATION. Various additives include carbon black, a process oil, a filler, sulfur, zinc oxide, a vulcanization accelerating agent, a processing aid, and a dehydration agent. A plurality of types of vulcanization accelerating agents including a thiuram-based agent and a thiazole-based agent were added. Note that the compositions in Table 1 differ only in the presence or absence of addition and the added amount of PEG4000 and EMULBON T-80, and all other materials are the same in the type, brand name, and amount. Similarly, for the compositions in Table 2, all materials excluding PEG4000 and EMULBON S-80 are the same in the type, brand name, and amount.

TABLE 1

| | | Comparative | | | |
|---|---|---|---|---|---|
| | | Example 1 | Example 1 | Example 2 | Example 3 |
| Composition | EPDM polymer | 100 | 100 | 100 | 100 |
| | PEG4000 | 0.5 | — | — | — |
| | EMULBON T-80 | — | 0.5 | 1.0 | 1.5 |
| | Various additives | 175 | 175 | 175 | 175 |
| Mooney viscosity | Vm | 30.5 | 29.2 | 29.1 | 29.0 |
| | t5 (min) | 6.4 | 6.1 | 6.1 | 6.4 |
| | t35 (min) | 8.0 | 7.6 | 7.7 | 8.2 |
| CURELASTOMETER | ML (kgf · cm) | 1.05 | 1.03 | 1.05 | 1.06 |
| | MH (kgf · cm) | 11.79 | 11.20 | 11.42 | 11.03 |
| | T10 (min) | 0.53 | 0.52 | 0.50 | 0.49 |
| | T90 (min) | 3.14 | 2.69 | 2.95 | 3.11 |
| Physical properties | Hardness | 44.7 | 43.2 | 42.5 | 42.5 |
| | Tb (MPa) | 10.7 | 12.0 | 13.6 | 13.6 |
| | Eb (%) | 504 | 550 | 592 | 608 |
| | Tear strength (N/cm) | 343.3 | 327.7 | 313.2 | 329.1 |
| | Compressive permanent | 17.5 | 14.0 | 14.5 | 15.3 |
| | set (%) 70° C.*22 h | | | | |
| | Compressive permanent | 19.3 | 16.8 | 18.3 | 18.3 |
| | set (%) 70° C.*72 h | | | | |

TABLE 2

| | | Comparative | Comparative | Comparative | | | |
|---|---|---|---|---|---|---|---|
| | | Example 2 | Example 3 | Example 4 | Example 4 | Example 5 | Example 6 |
| Composition | EPDM polymer | 100 | 100 | 100 | 100 | 100 | 100 |
| | PEG4000 | — | 0.5 | — | — | — | — |
| | EMULBON S-80 | — | — | 0.2 | 0.5 | 1.0 | 1.5 |
| | Various additives | 98.1 | 98.1 | 98.1 | 98.1 | 98.1 | 98.1 |
| CURE- | ML (kgf · cm) | 1.06 | 1.02 | 1.06 | 1.10 | 1.05 | 1.04 |
| LASTOMETER | MH (kgf · cm) | 9.10 | 8.90 | 9.09 | 8.88 | 8.81 | 8.72 |
| | T10 (min) | 0.94 | 0.93 | 0.93 | 0.92 | 0.96 | 0.98 |
| | T90 (min) | 4.23 | 4.19 | 4.20 | 3.94 | 4.16 | 4.19 |

### [Evaluation Method]

The rubber compositions in accordance with Examples and Comparative Examples were evaluated as follows.

### (Vulcanization Characteristics)

Mooney viscosity evaluation (125° C., 10 minutes) was carried out by a method in conformity to JIS K6300-1:2013 on vulcanization characteristics, such as a vulcanization rate, in a vulcanization reaction of the rubber composition. Evaluation using CURELASTOMETER (180° C., 10 minutes) was also carried out by a method in conformity to JIS K6300-2:2001. In the Mooney viscosity evaluation, the Mooney viscosity was evaluated for Vm, t5 (min) and t35 (min). The evaluation using CURELASTOMETER was carried out for ML (kgf·cm), MH (kgf·cm), T10 (min) and T90 (min). Results are indicated in Tables 1 and 2.

### (Heat Generation Property)

Heat generation property by ultra high frequency (UHF) was evaluated for the rubber composition. Specifically, a test piece (30 mm width, 100 mm length, 2 mm thickness) was cut out from a molded body of the vulcanized rubber composition. The test piece was placed at a position illustrated in FIG. 2 in a batch-type heating chamber provided with a UHF oscillator, and was caused to generate heat by oscillating UHF from a waveguide under the following UHF oscillation conditions, and a relationship between an oscillation time and a generated heat temperature was evaluated.

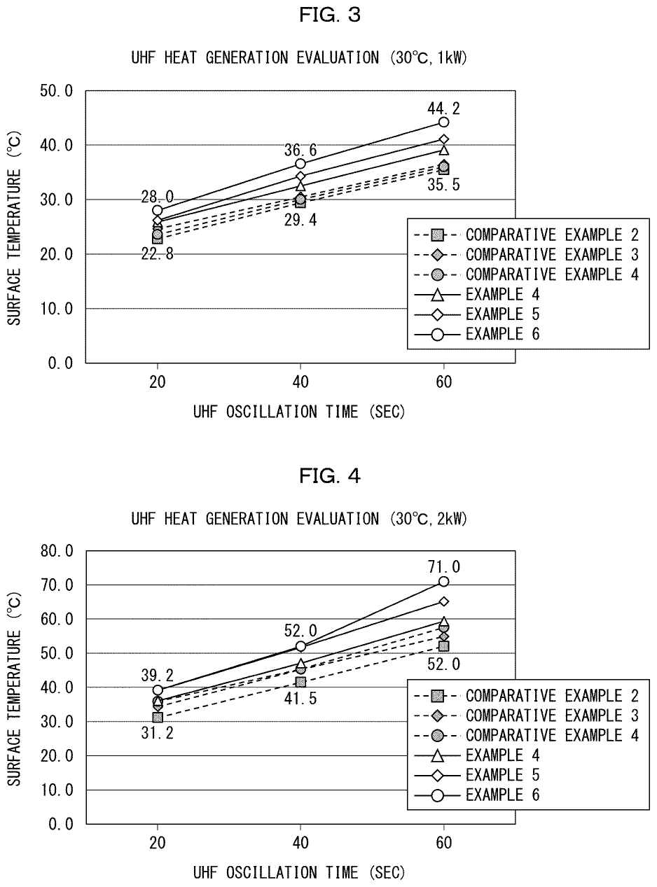

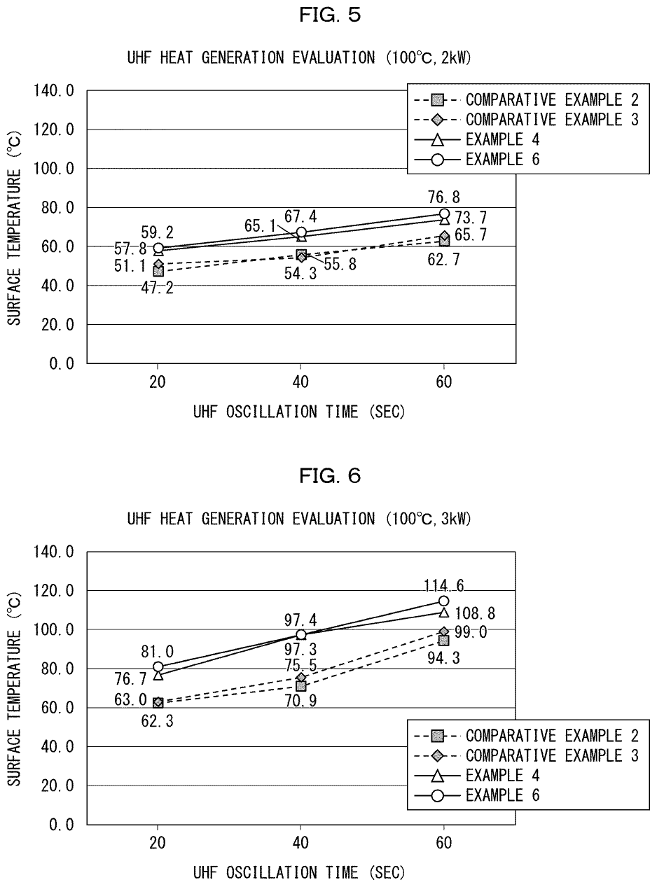

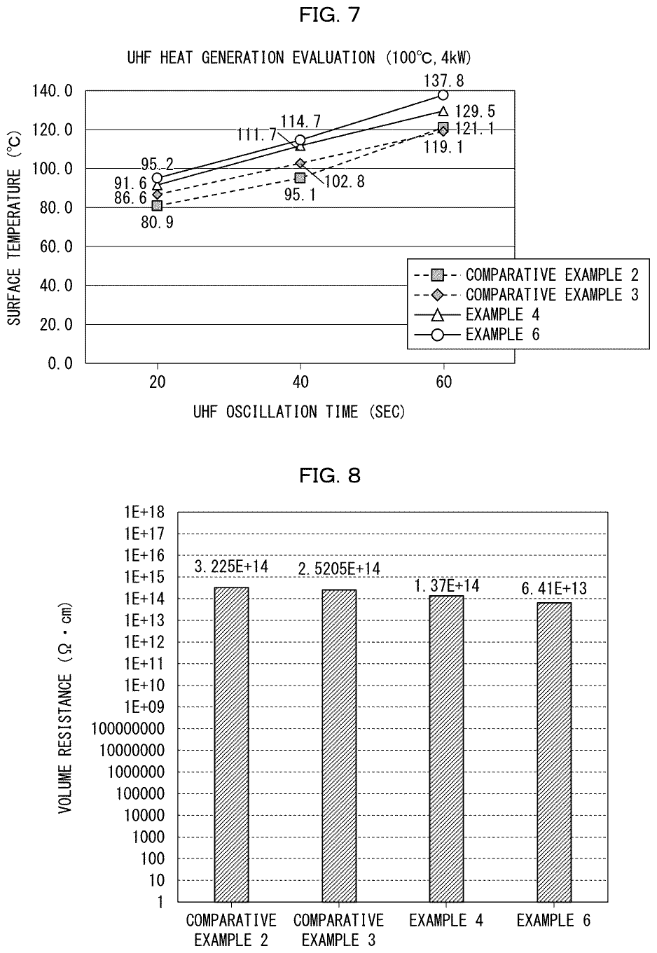

The UHF oscillation conditions were set as follows: the setting temperature was 30° C. or 100° C., the output was 1 kW to 4 KW, and the oscillation time was 20, 40, or 60 seconds. The temperature measurement position on the test piece was the center of the length and width of the test piece. After the oscillation time elapsed, a door of the heating chamber was opened, and the temperature measurement was completed within 10 seconds. For each of the test conditions, an average value was calculated for n=2. Results are illustrated in FIG. 3 through FIG. 7.

### (Mechanical Physical Properties)

Hardness of each of the molded bodies of the vulcanized rubber compositions was measured by a method in conformity to JIS K6253-3:2012. Tb (tensile strength at break, MPa) and Eb (elongation at break, %) were also measured by a method in conformity to JIS K6251: 2017. Tear strength (N/cm) was also measured by a method in conformity to JIS K6252-1:2015. The tear strength was measured after the molded body of the vulcanized rubber composition was cut out to have a shape of an angle-type test piece (without a notch). Compressive permanent set was also measured by a method in conformity to JIS K6262: 2013. The compressive permanent set was measured at a test temperature of 70° C. and for a retention time of 22 hours or 72 hours. Results are indicated in Table 1.

### (Electrical Conductivity)

A volume resistance value of each of the molded bodies of the vulcanized rubber compositions was measured by a method in conformity to JIS K6271-1:2015. For each of the test conditions, an average value was calculated for n=2. Results are illustrated in FIG. 8.

### [Results]

### (Manufacturability)

As indicated in Table 1, there was no major change in the value of t5 in the Mooney viscosity evaluation between Examples 1 through 3 and Comparative Example 1. The value t5 is also referred to as a scorch time, and a larger value is preferable because a larger value indicates a higher resistance to scorching. It was shown that the boron-based surfactant did not affect the scorch time of the rubber composition.

Meanwhile, in the evaluation using CURELASTOMETER, T90 was shortened in all Examples 1 through 3 as compared with Comparative Example 1, and the effect was particularly notable in Examples 1 and 2. The value T90 indicates the vulcanization rate, and a smaller value is preferable because a smaller value indicates a faster vulcanization rate. It was shown that the boron-based surfactant has the effect of improving the vulcanization rate of the rubber composition upon heating by thermal conduction.

As indicated in Table 2, T90 was shortened in Examples 4 and 5, as compared with Comparative Examples 2 and 3. Comparative Example 4 showed T90 that was equivalent to those in Comparative Examples 2 and 3. This indicated that the effect of improving the vulcanization rate of the rubber composition by the boron-based surfactant was obtained when the amount of the boron-based surfactant was greater than 0.2 parts by weight, relative to 100 parts by weight of the non-diene-based rubber. Example 6 showed T90 that was equivalent to those in Comparative Examples 2 and 3. From this, it was confirmed that no adverse effect was exerted on the vulcanization rate, provided that at least the contained amount of the boron-based surfactant was not more than 1.5 parts by weight.

As illustrated in FIGS. 3 through 7, in the UHF heat generation evaluation, the generated heat temperature for the same oscillation time was improved according to an increase in the contained amount of the boron-based surfactant under all of the UHF oscillation conditions. That is, it was shown that the addition of the boron-based surfactant led to shortening of the oscillation time for heat generation, and to improvement of the UHF heat generation property of the rubber composition.

Patent Literature 1 indicates that the dielectric constant is increased by the addition of PEG4000 to the rubber formulation. However, the comparison between Comparative Example 2 and Comparative Example 3 showed that the increase in dielectric constant due to PEG4000 had no substantial effect on UHF heat generation property. Examples herein showed that, by the boron-based surfactant, an advantageous effect from the viewpoint of manufacturability is obtained, i.e., the UHF heat generation property is improved, which was not obtained with a conventional surfactant such as PEG.

As described above, it was shown that the present rubber composition containing more than 0.2 parts by weight and not more than 1.5 parts by weight of the boron-based surfactant relative to 100 parts by weight of the non-diene-based rubber improved at least one of the vulcanization rate and the UHF heat generation property. As the vulcanization rate increases, it is possible to shorten the heating time during vulcanization. Moreover, as the UHF heat generation property increases, the temperature of the rubber composition can be increased faster. Both the effects are for reducing the time necessary for the vulcanization process of the rubber composition to improve heating energy efficiency. Therefore, it was suggested that the boron-based surfactant contributed to enhancement of the manufacturability and reduction of the production cost by improving the vulcanization characteristics of the rubber composition.

### (Mechanical Physical Properties)

As indicated in Table 1, in Examples 1 through 3, the values of Tb and Eb were improved as compared with Comparative Example 1, and the tensile characteristics as a rubber were favorable. In Examples 1 through 3, it was also shown that the compressive permanent set values were smaller than that in Comparative Example 1, and the resilience (elasticity) as a rubber was favorable. Thus, it was shown that the boron-based surfactant improved the vulcanization characteristics of the rubber composition to enhance the manufacturability, as well as improved the mechanical physical properties of the molded body of the vulcanized rubber composition.

### (Electrical Conductivity)

Preferable electrical conductivity of the rubber composition varies depending on the application. For example, in a case where the rubber composition is used for a component of an automobile such as a weather strip, excessively high electrical conductivity may cause a problem such as corrosion of a door. Under the circumstances, the influence of the boron-based surfactant on the electrical conductivity of the rubber composition was evaluated based on the volume resistance value.

As illustrated in FIG. 8, as compared with Comparative Examples 2 and 3, the change in volume resistance value in Examples 4 and 6 was less than one order of magnitude (less than 1/10), and no major change was seen. That is, it was shown that the boron-based surfactant had little influence on the electrical conductivity of the rubber composition and was able to be contained without any problem in both a conductive rubber and a non-conductive rubber.

### REFERENCE SIGNS LIST

100: Automobile
101: Door
102: Weather strip

1. A rubber composition, comprising a non-diene-based rubber and a boron-based surfactant,
a contained amount of the boron-based surfactant being more than 0.2 parts by weight and not more than 1.5 parts by weight, relative to 100 parts by weight of the non-diene-based rubber.

2. The rubber composition as set forth in claim 1, wherein the non-diene-based rubber is an ethylene-α-olefin-non-conjugated diene rubber.

3. The rubber composition as set forth in claim 1, wherein the boron-based surfactant is a glycerol borate fatty acid ester.

4. The rubber composition as set forth in claim 1, wherein said rubber composition is used for vulcanization molding using a vulcanization device which is provided with a UHF oscillator.

5. The rubber composition as set forth in claim 1, wherein said rubber composition is for a weather strip to be attached to a door of an automobile.

6. A weather strip to be attached to a door of an automobile, said weather strip comprising a portion constituted by a rubber composition recited in claim 5.
